(19) United States
(12) Patent Application Publication
(10) Pub. No.: US 2016/0366917 A1
(43) Pub. Date: Dec. 22, 2016

(54) A PROCESS FOR PREPARING A JUICE PRODUCT

(71) Applicant: SIEVECORP EUROPE B.V., Leek (NL)

(72) Inventors: Jorine ZANDHUIS, Leek (NL); Paul Willem MENDEL, Leek (NL)

(21) Appl. No.: 14/902,378

(22) PCT Filed: Jul. 11, 2014
(86) PCT No.: PCT/NL2014/050476

§ 371 Date: Dec. 31, 2015

(30) Foreign Application Priority Data
Jul. 12, 2013 (NL) 2011153

(51) Int. Cl. A23L 2/74; A23L 2/02; A23L 2/42

(52) U.S. Cl. CPC A23L 2/74; A23L 2/42; A23L 2/02; A23V 2002/00

(57) ABSTRACT

The invention is directed to a process for preparing a juice product from a raw juice feed comprising microorganisms by subjecting the raw juice feed to microfiltration to obtain the juice product and a retentate juice product, wherein the microfiltration is performed as a cross-flow filtration over a sieve, which sieve has openings that are smaller than the dimensions of the microorganisms present in the raw juice feed and wherein over the sieve a high frequency back pulsing is applied.

The invention is directed to a process for preparing a juice product from a raw juice feed comprising microorganisms and to the novel long shelf like juice product as obtained by this process.

There are various processes to make juice from fruit or vegetables. Typically juices are prepared from freshly cut or squeezed fruits or vegetables. In this process it is almost unavoidable that the juice will be contaminated by microorganisms. These microorganisms need to be removed from the juice in order to obtain a product which is allowable for human consumption. Especially for products which require a long shelf life a substantial reduction of these microorganisms is required. Various processes are known to reduce these microorganisms. Well known processes are pasteurisation and other heat treatments.

For example a coconut water product having acceptable shelf life may be prepared by pasteurization, for example by a low temperature long time (LTLT) process at about 145° F. (63° C.) for 30 min or a high temperature short time (HTST) process at about 162° F. (72° C.) for 15 s. A problem of this process is that the heat treatment can cause significant reduction in physical, nutritive and sensory quality of the product.

An alternative process to heat treatment is ultra-filtration as described in ‘Coconut water processing using ultrafiltration and pasteurization’, L. A. Nakano, et al., iCEF11 International Congress on Engineering and Food, May 22-26, 2011, Greece. This publication describes that an ultrafiltration process effectively reduces enzyme activity and reduce levels of microorganisms in coconut water. The results also show that coconut water obtained by ultrafiltration has the lowest score in sensory testing when compared to fresh coconut water and pasteurised coconut water.

Other processes which are currently also used for preparing vegetable or fruit juices are the so-called high-pressure process and pulsed electric field (PEF) process. In the former process the raw juice is subjected to a very high pressure during for example 15 minutes. In the latter, the raw juice is subjected to a high frequency of short electric field pulses at elevated temperatures (30-60° C.). PEF treatment time is less than one second but the juice stays at elevated temperature for approximately 45 seconds. In both processes micro-organisms are killed and it is stated that a 5 log reduction in microorganisms may be obtained. However, both processes are insufficiently effective to inactivate bacterial spores, which may germinate to growing and replicating bacteria during the shelf life of the juice, without applying additional heat. A further disadvantage of both methods is that the energy applied to the juice to inactivate microorganisms may also affect physical, nutritive and sensory quality of the product, albeit to a lesser extend than conventional pasteurization does.

In addition to the microorganisms the raw fruit juice may comprise enzymes originating from the fruit or vegetable that act on valuable juice ingredients such as; phenolic compounds; proteins; carbohydrates; and lipids, thereby degrading such ingredients and/or forming undesirable compounds. Examples of such enzymes are, polyphenol oxidases (PPO) and peroxidases (POD). It is well known that these enzymes are the main enzymes responsible for quality loss due to phenolic degradation and off-flavour and off-colour formation. See for example J Sci Food Agric 81:853-876. According to this paper heat treatment may inactivate these enzymes. High pressure and PEF processes may also inactivate these enzymes, although some authors recommend to combine these treatments with a mild thermal treatment to inactivate the POD and PPO enzymes.

In a paper published in the Journal of Food Processing and Preservation 20 (1996) 487-500 it is stated that coconut water contains polyphenol oxidases (PPO) and peroxidases (POD). The study reported in this paper shows that PPO and POD show enzyme activity at 5° C. of 46% respectively 39% in coconut water, as compared to PPO and POD activity in raw coconut water at 25° C. Thermal treatment results in that the enzyme activity decreases but adversely also in the breakdown of natural flavours and formation of off-flavours and off-colours.

GB2318969 describes a process to prepare coconut water having a long shelf life by a process involving a pre-filtering step, a centrifugation step to remove the majority of the polysaccharides and a micro-filtration to remove microorganisms. This document states that polyphenol oxidase enzymes can be inactivated by using commercially designed resins to avoid browning during storage. The process disclosed in GB2318969 has been commercialised and is referred to as the Microfiltration process for cold sterilisation of coconut water′ on the website of the applicant of this publication: Food and Agriculture Organisation of the United Nations. According to this website (http://www.fao.org/ag/magazine/9810/spot3add.htm) a clarifying resin such as polyvinylpolypyrrolidone (PVPP) (10 g/hl) is added to reduce the level of polyphenols and tannins and to improve the stability of the final coconut water. Said improved stability is caused by the inhibitive effect of PVPP on PPO.

A disadvantage of the method GB2318969 is that such steps as pre-filtering, centrifugation or resin addition may adversely remove valuable ingredients thereby affecting taste and/or nutritional value of the product. A further disadvantage is that it requires many process steps to achieve a product with good shelf life.

Although some of the above processes seem to provide a satisfactory juice product, a simple process that produces an improved juice with regard to both sensory and nutritional properties and shelf life is still desired.

An object of the invention is to provide a method for preparing a juice that does not have one or more of the above-described disadvantages of the prior art. In particular, it is an object of the invention to provide a method for preparing a juice, which method is easy to perform and results in a product having both good shelf life and good organoleptic properties such as taste.

At least one of these objects is achieved by the invention by providing the following process.

A process for preparing a juice product from a raw juice feed comprising microorganisms by subjecting the raw juice feed to microfiltration to obtain the juice product and a retentate juice product, wherein the microfiltration is performed as a cross-flow filtration over a sieve, which sieve has openings that are smaller than the dimensions of the microorganisms present in the raw juice feed and wherein over the sieve a high frequency back pulsing is applied.

Applicants found that by this relatively simple process a juice product could be obtained which has excellent sensory properties and a long shelf life. Using the process of the invention, a coconut water was obtained having a shelf life of more than 12 weeks, even at a relatively high temperature of 22° C., without any sensory loss compared to fresh coconut water (see Examples 1 and 2 below). Without wishing to be bound by any theory, it is expected that the specific microfiltration used and the mild conditions under which the process can be carried out contributes to the good shelf life and organoleptic properties of the product. Thus, the process results in a product which can be stored for a prolonged period of time under cooled or even ambient conditions, while retaining excellent taste.

This finding was unexpected because, in theory, the process does not remove, reduce or inactivate enzymes such as the active PPO and POD enzymes typically present in the juice feed. As explained above it is known that such enzymes may negatively affect the shelf life due to phenolic degradation and may result in off-flavour and off-colour formation. Therefore, the removal or inactivation of enzymes is a common processing step applied in the industry to guarantee long shelf life juices. Without wishing to be bound to the following theories applicants believe that the microfiltration according to the non-invasive process according to the present invention does not disrupt the natural balance present in the starting fruit or vegetable, for example the natural balance inside the coconut. By not disrupting this balance a more stable product is thus obtained. It might also be that the absence of microorganism residues (dead microorganisms or parts thereof), as are present in juices processed with heat, pressure or electrical fields, has a positive effect on product stability. Or it might be for a yet not understood reason or a combination of reasons that the product of the invention has a long shelf life.

A further advantage is that the process does not consume the high levels of energy as would a high temperature, high pressure or electric field process.

A further advantage is that the raw juice feed does not need to be contacted to a clarifying resin such as polyvinylpolypyrrolidone (PVPP) (10 g/hl). Such resins are commonly used to reduce the level of polyphenols and to improve the stability of juices by acting as inhibitor of PPO. However, such resins may also remove desirable phenolic compounds, proteins and lipids present in raw juice, which in turn may result in some sensory and nutritional loss. Moreover, the addition and subsequent removal of the resin present additional steps that make the process more complex.

The raw juice feed may be obtained by extracting juice from a fruit or vegetable and optionally subjecting the juice to one or more pre-treatment steps. In the present invention the term juice is directed to any fluid derived from a fruit or vegetable. Examples of possible fruits are apples, pears, pineapple, blueberries, blackberries, raspberries, coconuts, grapes, melon, mango, pomegranates, passion fruits, kiwis, citrus fruits, like oranges, lemons, mandarins, grapefruits. Examples of possible vegetables are carrots, tomato, celery, beets, spinach, broccoli, potato, aloe vera, rhubarb and legumes (in particular soy beans) or mixtures of the above fruits and/or vegetables. Very good results were obtained with coconuts, from which coconut water was derived as the juice. Similarly good results are expected to be obtained with apple juice, grape juice and pineapple juice.

The process of the invention is especially advantageous for processing a low acidic raw juice feed, preferably having a pH of above 4.6, because of heat, pressure and electrical field resistant bacterial spores, such as the botulism causing Closteridium botulinum spores, that may germinate in low-acid juices. Because of the high food safety risk presented by C. botulinum, the FDA requires a log 5 reduction of both bacteria and spores for low-acid juices, which can currently only be obtained by applying extreme heat or a combination of heat and other processing technologies significantly affecting physical, nutritional and sensory properties of the juice. Examples of low-acid juices are coconut water, carrot juice, mango juice, melon juice, aloe vera juice, beets juice, cactus juice, spinach juice and their mixtures. Very good results have been obtained for coconut water, as illustrated in the Examples.

The raw juice feed of the process, suitably has a turbidity of below 100 NTU preferably below 50 NTU, and more preferably below 20 NTU. Further, the raw juice feed may suitably have a water activity of above the 0.97, preferably above the 0.98 and even more preferably above the 0.99. Further, the raw juice may suitably have a dynamic viscosity of below the 8 mPa/s at the temperature of the raw juice feed and preferably below 5 mPa/s, more preferably below 3 mPa/s. Further, the raw juice may suitably have a total soluble solid content of below the 15° Bx, preferably below the 12° Bx and even more preferably below the 8° Bx. Generally, a raw juice feed having one or more of the above properties can be suitably subjected to the microfiltration process of the invention.

As will be clear to the person skilled in the art, the raw juice feed may be directly obtained from the fruit or vegetable or may have been treated by for example a centrifugal step, a homogenization step, storage step, mixing step, temperature adjustment step as well as combinations thereof. An example of such a pre-treatment is a course filtering step performed to remove larger particles and obtain the raw juice feed. The filter used may have a separation efficiency to reduce the content of particles having a size of between 10 to 100 μm and above. In view of the organoleptic properties of the juice, the raw juice feed is preferably obtained from the fruit or vegetable at a temperature below 40° C., preferably below 30° C., more preferably a temperature below 25° C. Any pre-treatment steps to obtain the raw juice feed are preferably conducted below such temperatures as well.

Applicants found that by using a coated silicon cross-flow surface plate as the sieve having well defined openings an almost total physical separation of microorganism from the raw juice feed is possible resulting in that a commercially sterilized juice product may be obtained in which physical, chemical, sensory and nutritional characteristics of the juice remain unchanged. The defined openings allow a sharp cut-off point so that all microorganisms are retained while all native juice ingredients are passed through unchanged. Additional advantages of said exact cut-off point are improved operational parameters such as increased flux rates and decreased fouling. Sieves comprising a coated silicon sieve having a surface plate as described above are known in the art.

The process of the invention does not require high pressure to obtain desirable results. Accordingly, the microfiltration step is preferably conducted at a pressure differential over the sieve plate of between 0 and 1.5 bar, more preferably between 0 and 1 bar, even more preferably below 0.5 bar and above 10 mbar. The pressure at the feed side of the microfiltration is preferably below 10 bar, more preferably below 5 bar, typically below 2 bar. Such pressures provide for an energy efficient process. Moreover, the use of such relatively low pressure and pressure differences may benefit the organoleptic properties of the product. A similar pressure differential may also be used in any filtering step that is conducted as a possible pre-treatment step.

The process of the invention does not require high temperature to obtain desirable results. Accordingly, the microfiltration step (or even the entire process) is preferably conducted at a temperature between 2 and 60° C., more preferably between 10 and 40° C., more preferably at room temperature (22° C.). Such temperatures provide for an energy efficient process.

In a preferred embodiment, the raw juice feed is not subjected to temperatures of 40° C. or higher, more preferably temperatures of 30° C. or higher, even more preferably temperatures of 25° C. or higher, during the process of the invention (i.e. in any step conducted therein). Since high temperatures are not vital for obtaining a good shelf life, the use of high temperatures can altogether be avoided in the process. This may be desirable as high temperatures may have a negative effect on the organoleptic properties of the juice.

Furthermore, the raw juice feed is preferably not subjected to pressures of 100 bar or higher, more preferably pressures of 10 bar or higher, even more preferably pressures of 5 bar or higher, during the process of the invention (i.e. in any step conducted therein, including any (pre-treatment) steps conducted to obtain the raw juice feed from the fruit or vegetable).

Current invention describes a process for preparing a juice product by a cross-flow filtration over a sieve, which sieve may comprise a coated silicon cross-flow surface plate and wherein over the sieve a high frequency back pulsing is applied. This specific microfiltration techniques is known in the art, e.g. from “Microfiltration of whole milk with silicon microsieves . . . ”, E. Brito-de la Fuente, Chem. Engineering Research and Design 88 (2010) 653-660. The technique may also be referred to as high-frequency cross-flow back-pulsing microfiltration. According to the invention, it is neither required nor preferred to perform any other step to remove micro-organisms than this microfiltration step.

The sieve used in the process of the invention has a membrane with openings (or ‘pores’) that are smaller than the dimensions of the microorganisms present in the raw juice feed. Best results have been obtained using a sieve that comprises a coated silicon cross-flow plate. However, other sieves may also be suitably used, provided that the sieve has sufficiently small and well defined openings. For example, it is envisioned that a metal plate having well defined openings as defined below may also serve as a suitable sieve.

A coated silicon cross-flow plate is a sieve that is manufactured from a silicon surface, e.g. from a silicon plate. The silicon surface may be coated to give the surface favourable characteristics. An example of such a coating is a coating that is employed to render the silicon surface more hydrophilic, such as a nitride coating. However, other coatings may be suitably used as well, such as ceramic coatings, crystalline coatings, polymer coatings, nanocoatings or monolayer coatings. In the silicon surface plate openings that account for the porosity and macrostructures serving for increasing the strength of the sieve or reducing the fouling potency of the sieve, may be manufactured by photolithographic techniques. An example of such a sieve plate and its manufacture is described in WO2005/023404 and EP-B-1667788, which publications (and in particular the product as defined in claim 1 of EP-B-1667788) are hereby incorporated by reference.

The thickness of the membrane of the sieve may be in the range of 0.2-2.0 μm, preferably 0.6-1.0 μm, even more preferably 0.7-0.9 μm. This thickness may in particularly refer to the thickness of the sieve or membrane at the openings of the coated silicon cross-flow plate. Such a small thickness is desirable, because it may enable the microfiltration to be conducted at a relatively low pressure differences while maintaining a good filtration yield.

The openings may have any form, such as a circular form or the form of a slit. The size of an opening is defined by the diameter of the inscribed circle of the opening.

Preferably the sieve has exactly defined openings resulting in a very sharp cut-off point. By well defined openings is meant that more than 90%, preferably more than 95% and even more preferred more than 99.9% of the openings in the sieve lies in range of the relevant dimensions specified herebelow (in particular the size of the opening as expressed by its diameter).

Accordingly, it is preferred that more than 90%, preferably more than 95%, more preferably more than 99%, and even more preferred more than 99.5% or even more than 99.9% of the openings in the sieve have about the same size (as defined by the diameter of inscribed circle of the openings). Openings are herein considered to have about the same size when the diameters of the inscribed circle of the openings lie within 160 nm, preferably within 100 nm of each other. Worded differently, for at least 90%, preferably at least 95%, more preferably at least 99%, even more preferably 99.5% or even 99.9% of the openings in the sieve, it holds that the difference in diameter between any two openings is 160 nm or less, preferably 100 nm or less. The openings in the sieve are smaller than the dimensions of the microorganisms such that these microorganisms cannot pass the cross-flow surface plate. This results in a process wherein more than 99.999% (log 5), preferably more than 99.99999% (log 7), preferably even more than 99.9999999% (log 9) of the number of microorganisms are separated from the raw juice.

Suitably the openings in the sieve are obtained by etching as exampled by the etching process described in the afore mentioned WO2005/023404 and EP-B-1667788. The openings may have for example a circular form or have the form of a slit. For a randomly shaped opening, the relevant dimension is the diameter of the opening's inscribed circle. The form of the opening is determined based on the shape of the opening on the surface of the sieve or cross-flow surface plate. The slit design is for example a circular opening extended in one direction. For a circular opening the relevant dimension is its diameter. For a slit form the relevant dimension is the distance between the two elongated sides of the slit, i.e. the width of the slit. The diameter or the width of the circular or slit form opening may be between 200 and 800 nm, more preferably between 300 and 600 nm and even more preferably between 350 and 500 nm as measured by means of a scanning electron microscope. Such a sieve plate will thus have very well defined openings that do not allow any microorganisms to pass. This is very advantageous compared to when using other microfiltration sieves, such as ceramic filters. Because the openings in ceramic filters used in prior art processes for juice and especially for raw coconut water are not well defined a log 5 or higher reduction of microorganisms is difficult to achieve or only possible by using filters having average openings well below the 350 nm. By not well defined openings is here meant that a distribution in sizes of the openings will exists for a specific filter. This results in that a percentage of the openings will have larger openings than 350 nm allowing microorganisms to pass and that a percentage will have smaller openings resulting in that valuable juice components, such as proteins, lipids and polysaccharides as present in the raw juice are separated from the juice resulting in loss of sensory and nutritional properties. Moreover, because of the smaller pores ceramic filters get easily fouled resulting in poor filtration efficiency. Also the presence of a small layer of retained materials such as microorganisms and proteins present at the retentate side of the micro porous layer may result in that such proteins, lipids and polysaccharides cannot pas the filter.

The sieve is preferably part of a microfiltration unit comprising an inlet space for the raw juice feed, an outlet for the juice product and an outlet for the retentate juice product, all fluidly connected to one or more parallel operated cross-flow units, each cross-flow unit comprising an inlet space fluidly connected to the inlet for raw juice feed and fluidly connected to the outlet for the retentate juice product, a permeate space fluidly connected to the outlet for the juice product, the coated silicon cross-flow surface plate fluidly dividing the inlet space from the permeate space.

Back pulsing may be achieved by interruption of the flow of raw juice to the sieve or more preferred by increasing the pressure at the permeate side of the cross-flow surface plate. Preferably the frequency of back pulsing is between 5 and 40 times per second. Preferably the permeate space of a cross-flow unit further comprises a buffer volume which increases and decreases in volume resulting in a temporal pressure reversal across the cross-flow surface plate such to achieve back pulsing. Such units are known and described in WO2008/127098 and especially as shown in FIG. 2 of WO2008/127098. Suitably the buffer is a bellow which can increase and decrease in volume. The bellow may for example increase in volume by pumping a gas into the below or more preferred by mechanically increasing its volume. The decrease of bellow volume will result from the pressure in the permeate space. Preferably the bellow is mechanically pressed to its larger volume at a frequency of between 5 and 40 times per second. The resulting backpulsing is very efficient in preventing fouling of the cross-flow surface plate with only minimal permeate loss. This is very advantageous for prolonging filtration runs while maintaining permeate flux rates.

The apparatus may comprise 1 or more parallel operated units. The number of units will in part depend on the required capacity. The modular design of the microfiltration apparatus makes scaling of filtration applications relatively easy.

Part of the retentate juice product may be recycled to the inlet space of the one or more cross-flow units. Such an operation is referred to as a cross-flow filtration, whereby the juice feed is pumped along the surface of the sieve plate facing the inlet space, with only a fraction of the juice feed passing the sieve plate to the permeate space. The retentate is preferably recycled and combined with the raw juice feed. A purge, i.e. the fraction of the retentate which is not recycled, will ensure that the level of microorganisms in the recycle will remain below an acceptable level. Applicants found that the purged retentate product may be used to prepare a second juice product by means of any prior art process suitable to reduce microorganisms, for example the processes described in the introductory part of this application. Thus by choosing the level at which the retentate is recycled one may influence the relative production of the juice product and the retentate juice product. The fraction of retentate product which is recycled may thus vary within wide ranges, for example between 10 and 100 vol % or between 10 and 99 vol %. If the main product is the juice product obtained by the process according to this invention and no substantial production of the retentate juice product is desired a recycle may be used wherein between 90 and 100 vol %, suitably between 90 and 99 vol % of the retentate juice product is recycled.

In the context of present invention, the term “long shelf life”, relates to juice products that typically have shelf lives longer than 4 weeks, when stored at 7° C.

The invention further relates to a juice product obtainable by the process of the invention. This product can amongst others be defined by its levels of viable microorganisms and the particle size (distribution) of the solid matter present in the product. Further properties of the juice product may be the presence of active PPO and POD enzymes and the resulting enzyme activity (in case such enzymes were present in the original juice and raw juice feed, e.g. in case of coconut water). Furthermore, the juice product may have a turbidity, water activity, dynamic viscosity and/or soluble solid content similar to that of the original juice, i.e. a value that lies within 10% of the value of the juice prior to pre-treatment and microfiltration according to the process of the invention.

The juice product is further defined by its flavour, which is identical or at least very similar to the taste of the original juice from the fruit from which it is obtained. The products known in the prior art (in particular coconut water) have distinct off-flavours, which are absent in the juice product when produced according to the method of the invention. It is expected that the superior taste of the juice product of the invention can be attributed to the specific microfiltration techniques used in the invention and the very mild processing conditions to which the juice is subjected during the process.

The juice product which may be prepared by the process of the invention will have low levels of viable microorganisms, such as bacteria, yeast, molds and bacterial spores. When measured immediately following processing and packaging (under aseptic conditions) the product may have a viable organism count, measured as colony forming units/millilitre by standard plate counts, between 0-500 cfu/ml, suitably between 0-100 cfu/ml and more preferably between 0-10 cfu/ml. In a preferred embodiment of the invention, the juice product contains 0 cfu/ml. Such low levels of microorganisms are very advantageous for product safety and product stability. In particular the low level of bacterial spores provides the product of the invention with relatively high food safety compared to prior art products. Such spores are often heat, pressure and/or electrical field resistant.

The juice product which may be prepared by the process of the invention may comprise very low levels of dead microorganisms or microorganism residues. Such low levels of microorganism residues cannot be obtained by prior art methods using specific forms of energy, such as heat, pressure or electrical fields, to inactivate the microorganisms without physically removing the microorganisms. It is contemplated that the low levels of microorganism residues may have a positive effect on the quality and stability of the product of the invention. It might be that by physically removing the microorganisms the content of bacterial enzymes in the product is lower and/or that there is less substrate present for native enzymes.

Preferably, at least 95 wt. %, more preferably at least 99 wt. %, even more preferably 99.9 wt. % of the dry matter present in the juice product which may be prepared by the process of the invention has a particle size smaller than 800 nm, more preferably smaller than 500 nm. This value may be suitably measured by laser diffraction, e.g. using a Malvern Mastersizer. As used herein, the dry matter refers to any components in the product other than water. In comparison with prior art microfiltration processes, the dimension of the biggest particles in the product are relatively big. This indicates that the properties of the raw juice are better preserved in the juice product of the invention. This is particularly beneficial in the light of the growing consumer demand for minimally processed juices.

The juice product which may be prepared by the process of the invention may comprise enzymes originating from the fruit or vegetable, such as PPO and POD. The enzymes present in the juice product are typically present in their native form. Accordingly, the enzymes may still show enzyme activity, as can be determined using enzyme arrays. PPO activity may be determined using a fluorometric assay and may be above 70%, suitably above 80% and preferably above 90% of the enzyme activity in the raw juice feed. POD activity may be determined using a fluorometric assay and may be above 70%, suitably above 80% and preferably above 90% of the enzyme activity in the juice feed. Enzyme activity may thus be relatively high compared with prior-art processes in which the enzymes are inactivated. This is generally thought to be disadvantageous due to a negative effect on product stability by phenolic degradation and off-flavour and off-colour formation. However, the inventors found that despite of the high enzyme activity the juice product still has a long shelf life. Although the POD activity may vary depending on the specific type of fruit used, the juice product obtained in the process of the invention will generally have a POD activity above 50 IU/L, typically above 75 IU/L.

The juice product which may be prepared by the process of the invention may have high levels of total phenolic compounds. When measured immediately following processing and packaging the product may have a total phenolic compound content, as measured with a spectrophotometer after usage of the Folin-Ciocalteu assay, of above 75%, suitably above 90% and preferably above the 95% of the total phenolic compounds content of the raw juice feed. Accordingly, in case of coconut water, the total phenolic content may be more than 15 mg/l, preferably more than 25 mg/l. High levels of phenolic compounds are highly desirable because such compounds provide the juice product with very beneficial sensory characteristics, a high anti-oxidant capacity and other health related benefits. However, because of the volatile nature of phenolic compounds it is difficult to preserve them during juice processing. It is generally known that heat treatment results in significant phenolic degradation and also pressure and electric fields may reduce the total phenolic compound levels, albeit to a lesser extend. Moreover, in prior art processes using commercial resins to remove PPO enzymes the total phenolic content is also significantly reduced.

Preferably the juice is coconut water. The term coconut water as used herein in particular refers to the clear liquid fluid that can be found in the inside of a coconut. Coconut water may consist of at least 80 wt. % water, typically at least 90 wt. % water. Further, coconut water typically has a high potassium content, e.g. 100-500 mg per 100 g (which corresponds to about 5 wt. % of the total weight of coconut water).

The invention is also directed to the following coconut water composition having a viable organism count, measured as colony forming units/millilitre by standard plate counts of between 0-100 cfu/ml, suitably between 0-50 cfu/ml and more preferably between 0-10 cfu/ml and most preferred of 0 cfu/ml. The composition further has a very low level of dead microorganisms or residues of dead microorganism. Preferably, at least 99 wt. % of the dry matter present in this coconut water has a particle size smaller than 500 nm. The novel coconut water further comprises PPO and POD enzymes. These enzymes originate from the coconut and are in their native form as indicated by relatively high activities.

The juice product obtained by the process may be mixed with other liquids (e.g. juices), thus obtaining a mixed juice product. Additives may be added, such as colorants, sugars, aspartame, Stevia or pulp. The juice may be bottled or stored in large containers and transported to their markets. The juice may also be deep cooled, frozen or chilled for enabling long distance transport. The juice may be used as substance for other food products.

The invention will be illustrated by the below example.

### EXAMPLE 1

### Shelf Life

A raw coconut water feed was extracted from young Nam Hom coconuts from Thailand. Only just before performing the process according to the invention the coconuts were opened with a knife and the raw coconut water was poured through a woven nylon prefilter cloth with 15 μm openings to obtain a pre-filtered raw feed. The pre-filtered water from different coconuts was pooled into one container, which had been cleaned with alcohol. From this container, 1 liter was transferred to a sterile sampling pot. This sample served as control liquid in the shelf life test.

The pre-filtered raw coconut water as contained in the container was processed by means of a cross-flow microfiltration over a sieve, comprising of a coated silicon cross-flow surface plate of a thickness of 1 μm and with well defined openings that are smaller than 500 nm. Prior to performing the process the cross-flow separation equipment was disinfected using 1 v/v % Divosan Forte at room temperature for 15 minutes. The pressure at the feed side of the sieve was 500 mbar. The pressure difference over the sieve was 100 mbar. The backpulsing frequency was 35 Hz and the backpulsing amplitude was 300 mbar. The temperature of the raw coconut water feed was 25° C. The coconut water obtained at the permeate side was collected in two 2 L sterile bags.

Both the filtered and the unfiltered coconut water were stored in a cooler, transported to a laboratory the same day and stored over night in a dark refrigerator at 4° C. The following morning, both samples were subdivided into small sterile containers in a laminar flow cabinet. The containers were filled to the top to minimize oxygen availability. The unfiltered coconut water samples; half of the filtered coconut water samples; and 12 unopened coconuts; were stored in a dark refrigerator at 7° C. The other half of the filtered coconut water was stored in the dark at 22° C.

### Microbial Analysis

The microbial analysis was performed on the filtered coconut water stored at 7° C.; the filtered coconut water stored at 22° C.; and the pre-filtered raw coconut water. The first microbial analyses were performed just after the initial sample preparation, thereafter, the analyses were repeated each two weeks. After 28 days the untreated water was heavily contaminated and the microbiological analysis for these samples was stopped. The water was tested for aerobic bacteria, yeast and molds using standard plate counts.

### Sensory Testing

The sensory testing was performed on the filtered coconut water and on the fresh coconut water from a just opened nut. The first analysis is performed just after the initial sample preparation, thereafter, the analysis is repeated each week. A trained expert panel performed the sensory testing. The water was rated for appearance and taste. For the taste the panel focused on nutty, soapy, rancid, and off flavours.
The microbiological results are presented in table 1.

TABLE 1

| | | Filtered | Filtered | |
|---|---|---|---|---|
| Day | Tests | 7° C. | 22° C. | Untreated |
| 0 | Aerobic bacteria | <10 | <10 | 7.6 × 10² |
| | (CFU/ml) | | | |
| | Yeast (CFU/ml) | <10 | <10 | 9.0 × 10¹ |
| | Moulds (CFU/ml) | <10 | <10 | <10 |
| 14 | Aerobic bacteria | <10 | <10 | >10⁸ |
| | (CFU/ml) | | | |
| | Yeast (CFU/ml) | <10 | <10 | 1.9 × 10⁴ |
| | Moulds (CFU/ml) | <10 | <10 | <10 |
| 28 | Aerobic bacteria | <10 | <10 | >10⁸ |
| | (CFU/ml) | | | |
| | Yeast (CFU/ml) | <10 | <10 | 1.0 × 10⁵ |
| | Moulds (CFU/ml) | <10 | <10 | <10 |
| 42 | Aerobic bacteria | <10 | <10 | — |
| | (CFU/ml) | | | |
| | Yeast (CFU/ml) | <10 | <10 | — |
| | Moulds (CFU/ml) | <10 | <10 | — |
| 56 | Aerobic bacteria | <10 | <10 | — |
| | (CFU/ml) | | | |
| | Yeast (CFU/ml) | <10 | <10 | — |
| | Moulds (CFU/ml) | <10 | <10 | — |
| 70 | Aerobic bacteria | <10 | <10 | — |
| | (CFU/ml) | | | |
| | Yeast (CFU/ml) | <10 | <10 | — |
| | Moulds (CFU/ml) | <10 | <10 | — |
| 84 | Aerobic bacteria | <10 | <10 | — |
| | (CFU/ml) | | | |
| | Yeast (CFU/ml) | <10 | <10 | — |
| | Moulds (CFU/ml) | <10 | <10 | — |
| 98 | Aerobic bacteria | <10 | <10 | — |
| | (CFU/ml) | | | |
| | Yeast (CFU/ml) | <10 | <10 | — |
| | Moulds (CFU/ml) | <10 | <10 | — |

### Sensory Results

A trained expert panel tasted the filtered coconut water stored at 7° C. and the filtered water stored at 22° C. every two weeks and compared it to the taste of coconut water from a freshly opened coconut. During the period of the shelf life test (98 days) the panel could not discern between the taste of the filtered coconut water samples, independent of storage temperature, and the taste of water fresh from the coconut.
Example 1 indicates that product according to the invention has a very long shelf life, both refrigerated and under ambient temperatures. During the shelf life the taste of the product remains indiscernible from fresh coconut water.

### EXAMPLE 2

### Taste Comparison

A raw coconut water feed was extracted from young Nam Hom coconuts from Thailand. After extraction, the raw coconut water was pre-filtered using first a nylon bagfilter with 10 μm nominal pore size and thereafter a polypropylene cartridge filter with 10 μm absolute pore size. After prefiltration the coconut water is filled out into PET bottles and frozen and stored at −18° C. until treatment.

### Treatments

The frozen coconut water was subdivided into four fractions. All fractions are thawed at 4° C. The first fraction was treated using high pressure pasteurization. In this treatment the bottles containing the coconut water were pressurized using 6000 bar for 3 minutes. The second fraction was pasteurized at 100° C. for 12 seconds. The third fraction was filtrated using the methods of example 1. The fourth fraction was thawed immediately before taste analysis without any further treatment. This fraction is used as reference in the sensory comparison.

### Commercially Available Products

In addition to the high pressure pasteurized, pasteurized and filtrated Nam Hom coconut water, also samples of two commercially available coconut water products were included into the sensory comparison. The first commercial product is Vita Coco pure coconut water. Vita Coco uses coconuts from Brazil and Asia. They add natural fruit sugar to standardize the sweetness level of their products and presumably also vitamin C to lower the pH of their product. Thereafter, they pasteurize their coconut water at 120° C. for 5 seconds. The second commercial product is Coco Juice from Dr. Antonio Martins. Dr. Martins sources the coconuts from Sri Lanka, Brazil and the Philippines. The coconut water is made according to the method described in AT501237. This method consists of the following steps: extraction of the coconut water at the country of origin; pasteurization of the coconut water at 60-90° C. for 15 seconds to 10 minutes; frozen transport to the factory in Europe; microfiltration using polymeric or ceramic filters with a pore size of 0.05 to 0.4 μm; pH correction using acid to lower the pH; pasteurization at 60-90° C. for 15 seconds to 10 minutes; and finally bottling the product.

### Sensory Analysis

The taste of the Nam Hom coconut water samples (high pressure pasteurized, heat pasteurized and filtrated) and the commercial coconut water products (Vita Coco and Dr. Martins Coco Juice) are tested using a paired comparison test according to standard DIN EN ISO 5495. A trained sensory panel consisting of six panelists performed the analysis. Each assessor was presented with two samples (A and B) simultaneously. Half of the panel tasted sample A first, while the remaining tasted sample B first. The panelists were asked to answer the question: “is there a difference between the reference and the sample? As reference the untreated Nam Hom fraction was used. The panelists focused on the attributes: nutty flavour, sweetness and off flavour.

### Results

The results of the sensory comparison are presented in table 2.
The results of example 2. indicate that the product according to the invention has a taste that is equal to the taste of coconut water fresh from the coconut. In contrast, the taste of coconut water treated with processes known from the prior art is affected in comparison with fresh water. The taste can be less nutty, sweeter, sour and off flavours can be developed.

TABLE 2

| | Nutty | | |
|---|---|---|---|
| Products | flavour | Sweetness | Off flavour |
| Reference | Perfect nutty | Slightly sweet | No |
| (untreated) | | | |
| High pressure | Low nutty | Sweet | Old and Fade |
| pasteurization | | | |
| Heat | Very low | Slightly sweet | No |
| pasteurized | nutty | | |
| Filtrated | Perfect nutty | Slightly sweet | No |
| Vita coco | Very low | Not sweet, very | Fade, slightly off |
| | nutty | low sour | flavour |
| Dr. Martins | Very low | Not sweet, sour | Very intense off |
| Coco Juice | nutty | like lemon taste | flavour, unnatural, |
| | | | atypical. |

### EXAMPLE 3

### Microbiological Reduction

To test the microbiological reduction Listeria innocua was selected as challenge organism. Listeria monocytogenus is the smallest bacterium of food safety relevance that could be identified. L. innocua is a non-pathogenic model organism that has the same size as L. monocytogenus. L. innocua was inoculated in a growth medium and put to grow at 37° C.

When the concentration of the L. innocua culture was high enough, the bacteria were transferred to diluted peptone buffered water. Diluted peptone buffered water is a minimal medium causing the cell size of bacteria to be relatively small compared to rich growth media. Therefore, this medium was selected as worse case scenario.

The inoculated peptone water was filtered according to the method described in example 1. Also a sample was taken for determination of the start concentration of Listeria. The permeate was transferred directly into sterile sample containers. The filtration was performed in duplicate.

Microbiological analysis was performed for the unfiltrated peptone water and the filtrated peptone water. The samples were tested on Listeria innocua using standard plate counts.

The results of the microbiological analysis are presented in table 3.

TABLE 3

| | Listeria innocua |
|---|---|
| Sample | (CFU/ml) |
| Unfiltrated peptone | 1.1 * 10⁷ |
| water | |
| Filtrated peptone water 1 | <10 |
| Filtrated peptone water 2 | <10 |

The results of example 3. indicate that the process according to the invention results in at least a log 99.99999% (log 7) reduction. To prove even higher reductions the experiment should be repeated with higher start concentration.

### EXAMPLE 4

### Particle Size Distribution

Nam Hom coconut water samples treated with (a) high pressure pasteurization, (b) heat pasteurization and (c) filtration according to example 1 (invention), (d) the commercial product Vita Coco pure coconut water or (e) the commercially available product Dr. Martins Coco Juice were obtained as described in example 2. As reference untreated, non-prefiltered, Nam Hom water was used.

The particle size distribution of the coconut water samples was determined with laser diffraction analysis using a Malvern Mastersizer 2000.

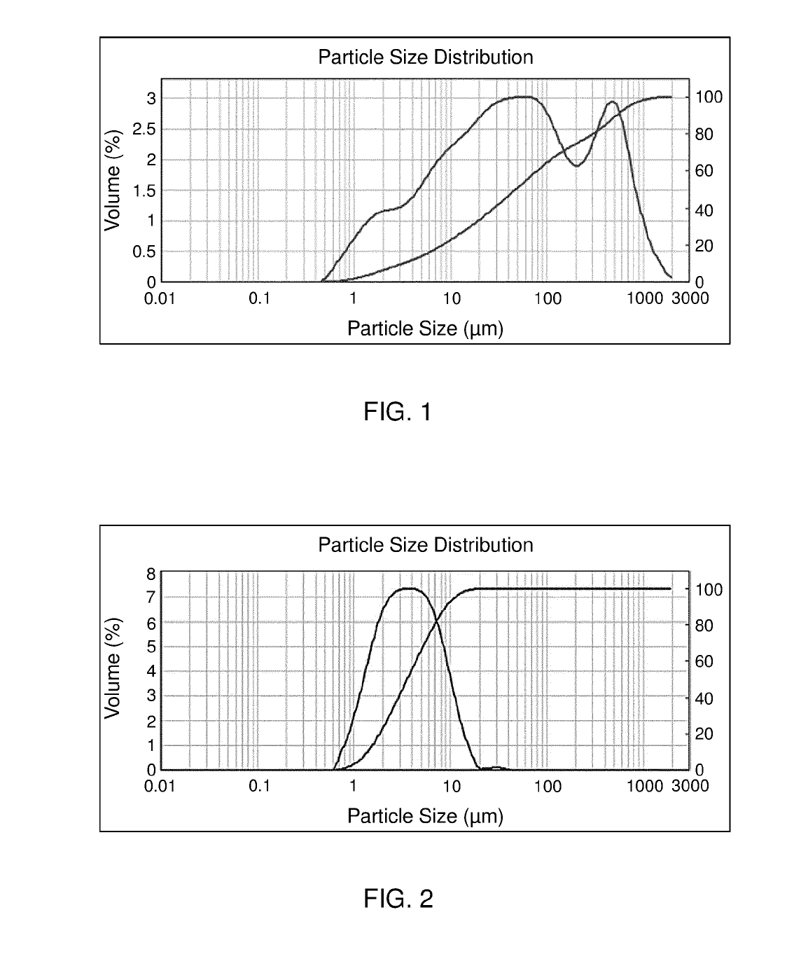

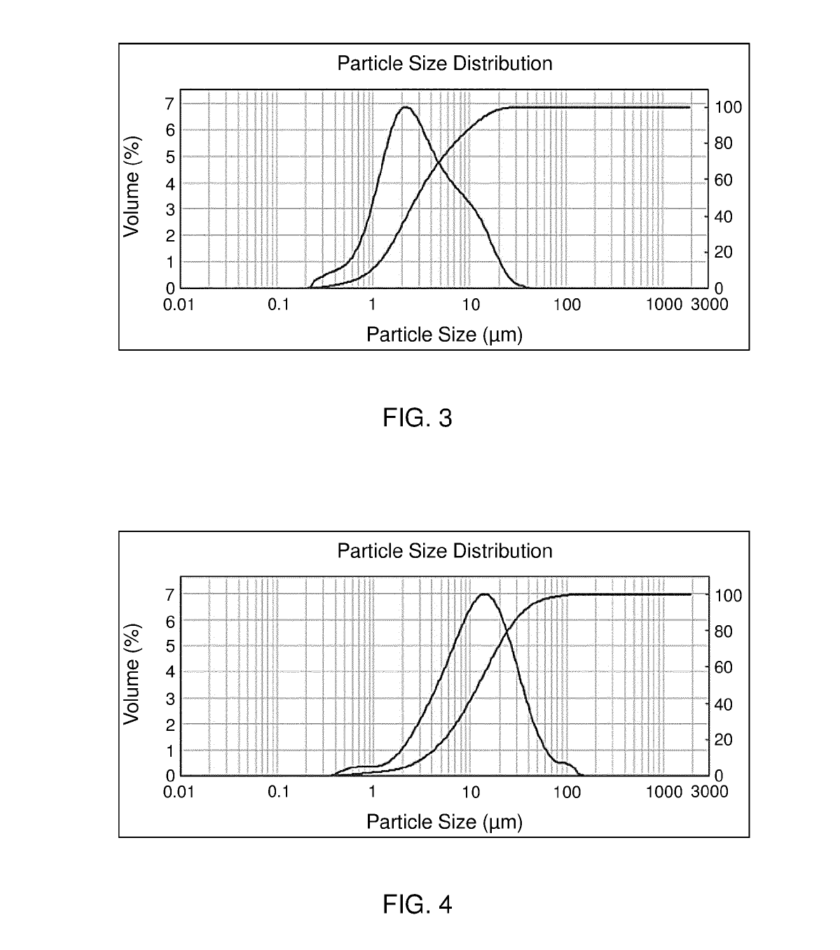

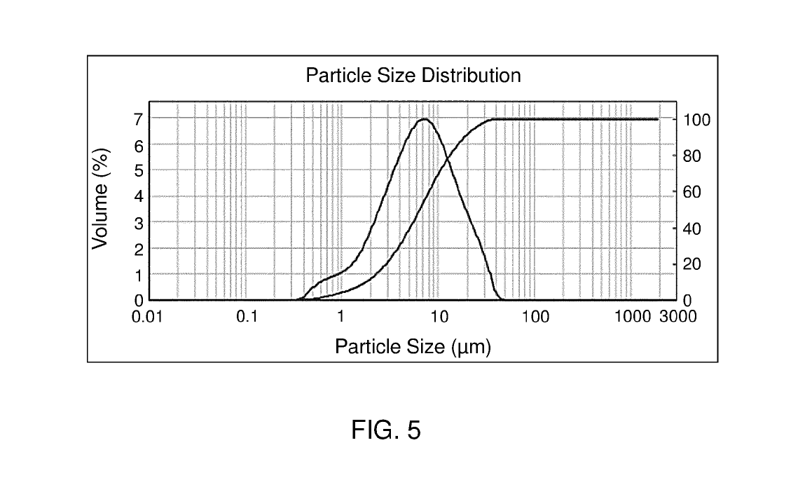

The results of the particle size distribution for the reference, high pressure pasteurized Nam Hom, heat pasteurized Nam Hom, Vita Coco and Dr. Martins Green Coco are presented in FIG. 1-5. Notably, for the microfiltrated Nam Hom samples (c) no particle size distribution could be obtained. It was concluded that particle concentration was below the detection limit of the Mastersizer for this particular fluid. As can be seen in FIG. 1, there is only a negligible fraction of particles smaller than 500 nm in the original, untreated coconut water. The fact that after filtration no particle size distribution could be obtained indicates that all particles bigger than 500 nm has been filtered out and there is no significant amount of particles smaller than 500 nm.

Example 4. Indicates that the product according to the invention has a very low particle concentration. It is plausible that the concentration is low because the filter retains most particles with a size bigger than 0.4 μm. As can be seen in FIG. 1. coconut water barely contains particles smaller than 0.4 μm. Because of the low particle concentration, the filtered product differs from the untreated, heat treated and high-pressure pasteurized products.

### EXAMPLE 5

### Product Characteristics

Filtered coconut water was obtained as described in example 1. From the 2 L bag, the water was subdivided into small sterile sample pots in a laminair flow cabinet. As reference sample coconut water was drawn from fresh coconuts immediately before analysis. pH determination
The pH of the filtered and reference coconut water was measured using a Sentron SI line pH meter which is based on a ion-sensitive field-effect transistor. Before measurements a two-point calibration was performed using the Sentron Buffers #2 and #3.

### Brix Measurements

The brix of the filtered and reference coconut water was measured using an optical refractometer.

### Peroxidase Activity

The peroxidase activity of the filtered and the reference coconut water was measured using the BioChain Peroxidase Assay Kit. This kit uses a fluorimetric procedure using H2O2 as enzyme substrate.

### Total Phenolics

The total phenolic content of the filtered and the reference coconut water was determined using the Folin-Ciocalteu method and reagent.
The results of the measurements are presented in table 4.

TABLE 4

| | Untreated coconut | |
|---|---|---|
| Parameter | water | Filtered coconut water |
| pH | 5.2 | 5.2 |
| Brix (°Bx) | 7.7 | 7.7 |
| Peroxidase activity | 87.7 | 113.6 |
| (IU/L) | | |
| Total phenolics (mg/L) | 94 | 84 |

The results of example 5. show that the filtered coconut water still has enzyme activity. This activity is even higher than in the begin product. This is remarkable, especially in combination with the long shelf life results of example 1. It was expected that for a long shelf life enzyme deactivation is necessary. This seems not to be the case.

Furthermore, the results of example 5. show that the filtered coconut water is very comparable to the untreated coconut water. pH and Brix are equal, and phenolic contents were measured to be similar as the untreated coconut water with a difference margin of around 10%.

### EXAMPLE 6

### Shelf Life and Chemical Analysis

A raw coconut water feed was extracted from young green dwarf coconuts from Thailand. Only just before performing the process according the invention the coconuts were opened with a knife and the raw coconut water was poured through a woven nylon prefilter cloth with 15 μm openings to obtain a pre-filtered raw feed. The pre-filtered water from different coconuts was pooled into one container, which had been cleaned with alcohol. From this container, 1 liter was transferred to a sterile sampling pot. This sample served as control liquid in the shelf life test.

The pre-filtered raw coconut water as contained in the container was processed by means of a cross-flow microfiltration over a sieve, comprising of a coated silicon cross-flow surface plate with well defined round openings having a diameter of 0.45 μm. Prior to performing the process the cross-flow separation equipment was disinfected using 1 v/v % Divosan Forte at room temperature for 15 minutes. The pressure at the feed side of the sieve was 500 mbar. The pressure difference over the sieve was 100 mbar. The backpulsing frequency was 25 Hz and the backpulsing amplitude was 300 mbar. The temperature of the raw coconut water feed was 22° C. The coconut water obtained at the permeate side was collected in a 2 L sterile bag.

Both the filtered and the unfiltered coconut water were stored in a cooler, transported to a laboratory the same day and stored over night in a dark refrigerator at 4° C. The following morning, both samples were divided into 10 sterile containers in a laminar flow cabinet. The containers were filled to the top to minimize oxygen availability. 2 filtered and 2 unfiltered samples were used for the first analysis round. The remaining 8 unfiltered and 8 filtered samples were stored in a dark refrigerator at 7° C., together with 8 fresh unopened coconuts.

### Chemical Analysis

The chemical analysis was performed just after the initial sample preparation. 1 sample of the filtered and 1 sample of unfiltered coconut water were used for determination of the protein, fat, glucose, fructose, sucrose, maltose and lactose content. The results are presented in the below Table 5.

TABLE 5

| | Filtered | |
|---|---|---|
| | coconut | Coconut |
| Parameter | water | water feed |
| Protein (g/100 g) | <0.5 | <0.5 |
| Fat (g/100 g) | <0.2 | <0.2 |
| Saccharose (g/100 g) | 0.98 | 0.98 |
| Glucose (g/100 g) | 2.11 | 2.16 |
| Fructose (g/100 g) | 1.87 | 1.97 |
| Maltose (g/100 g) | <0.3 | <0.3 |
| Lactose (g/100 g) | <0.3 | <0.3 |
| Phosphor (mg/100 g) | 21 | 21 |
| Natrium (mg/100 g) | 20.2 | 20.2 |
| Potassium (mg/100 g) | 225 | 225 |
| Magnesium (mg/100 g) | 15.6 | 15.7 |
| Calcium (mg/kg) | 215 | 237 |

### Microbial Analysis

The microbial analysis was performed on the filtered coconut water, pre-filtered raw coconut water and fresh coconut water from a just opened nut. The first microbial analyses for were performed just after the initial sample preparation, thereafter, the analyses are repeated each week. The water was tested for aerobic bacteria, yeast and molds using standard plate counts.

### Sensory Testing

The sensory testing was performed on the filtered coconut water and on the fresh coconut water from a just opened nut. The first analysis is performed just after the initial sample preparation, thereafter, the analysis is repeated each week. A trained expert panel performed the sensory testing. The water was rated for appearance and taste. For the taste the panel focused on nutty, soapy, rancid, and off flavours. At the time of filing this application the experiment was still ongoing.
The results are presented in Table 6.

TABLE 6

| | | Filtered coconut | pre-filtered raw |
|---|---|---|---|
| Day | Tests | water | coconut water |
| 0 | aerobic bacteria | <10 | <10 |
| | (CFU/ml) | | |
| | Yeast (CFU/ml) | <10 | <10 |
| | Moulds (CFU/ml) | <10 | <10 |
| | Taste | No difference with | — |
| | | fresh coconut water | |
| 7 | aerobic plate count | <10 | 3.10E+03 |
| | yeast | <10 | <10 |
| | moulds | <10 | <10 |
| | Taste | No difference with | — |
| | | fresh coconut water | |
| 14 | aerobic plate count | <10 | 1.40E+06 |
| | yeast | <10 | <10 |
| | moulds | <10 | <10 |
| | Taste | No difference with | — |
| | | fresh coconut water | |
| 21 | aerobic plate count | <10 | 1.00E+08 |
| | yeast | <10 | <10 |
| | moulds | <10 | <10 |
| | Taste | No difference with | — |
| | | fresh coconut water | |
| 28 | aerobic plate count | <10 | 2.50E+08 |
| | yeast | <10 | <10 |
| | moulds | <10 | <10 |
| | Taste | No difference with | — |
| | | fresh coconut water | |
| 35 | aerobic plate count | n.m | n.m. |
| | yeast | n.m. | n.m. |
| | moulds | n.m. | n.m. |
| | Taste | No difference with | — |
| | | fresh coconut water | |

The invention claimed is:

1. A process for preparing a juice product from a raw juice feed comprising microorganisms by subjecting the raw juice feed to microfiltration to obtain the juice product and a retentate juice product, wherein the microfiltration is performed as a cross-flow filtration over a sieve, which sieve has openings that are smaller than the dimensions of the microorganisms present in the raw juice feed and wherein over the sieve a high frequency back pulsing is applied.

2. The process according to claim 1, wherein the sieve comprises a coated silicon cross-flow surface plate with openings that are smaller than the dimensions of the microorganisms present in the raw juice feed and wherein over the sieve a high frequency back pulsing is applied.

3. The process according to claim 1, wherein the openings in the coated silicon cross-flow surface plate have a circular or slit form opening wherein the diameter of the circular opening or the width of the slit has a length of between 200 and 800 nm.

4. The process according to claim 1, wherein for at least 99.5% of the openings in the sieve, the difference in the diameter of the inscribed circle between any two openings is 160 nm or less, preferably 100 nm or less.

5. The process according to claim 1, wherein the diameter of the inscribed circle of at least 95%, preferably at least 99%, more preferably at least 99.5%, even more preferably at least 99.9% of the openings lies within a range of 300-500 nm.

6. The process according to claim 1, wherein the membrane of the sieve has a thickness of 0.2-2.0 μm.

7. The process according to claim 1, wherein the openings have been obtained by etching.

8: The process according to claim 1, wherein the frequency of back pulsing is between 5 and 40 times per second.

9. The process according to claim 1, wherein the sieve is part of a microfiltration unit comprising an inlet space for raw juice, an outlet for the juice product and an outlet for the retentate juice product, all fluidly connected to one or more parallel operated cross-flow units, each cross-flow unit comprising an inlet space fluidly connected to the inlet for raw juice and fluidly connected to the outlet for the retentate juice product, a permeate space fluidly connected to the outlet for the juice product, the coated silicon cross-flow surface plate fluidly dividing the inlet space from the permeate space.

10. The process according to claim 9, wherein the permeate space of a cross-flow unit further comprises a buffer volume which increases and decreases in volume resulting in a temporal pressure reversal across the cross-flow surface plate such to achieve back pulsing.

11. The process according to claim 1, wherein more than 99.999% (count) of the microorganisms are separated from the raw juice.

12. The process according to claim 1, wherein the raw juice feed comprises has a turbidity of below 100 NTU, a water activity of above the 0.97, a dynamic viscosity of below 5 mPa/s and a total soluble solid content of below the 15° Bx.

13. The process according to claim 1, wherein the juice product has a pH greater than 4.8.

14. The process according to claim 1, wherein the raw juice feed is coconut water obtained from coconuts.

15. The process according to claim 1, wherein the microfiltration step is conducted at a pressure differential over the sieve plate of between 0 and 1.5 bar, more preferably between 0 and 1 bar, even more preferably below 0.5 bar and above 10 mbar.

16. The process according to claim 1, wherein the raw juice feed is not subjected to temperatures of 40° C. or higher, more preferably temperatures of 30° C. or higher, even more preferably temperatures of 25° C. or higher, during the process.

17. A juice product obtainable by the method of claim 1.

18. Coconut water having a viable organism count, measured as colony forming units/millilitre by standard plate counts of between 0-100 cfu/ml, wherein at least 99 wt. % of the dry matter present in this coconut water has a particle size smaller than 500 nm and wherein the coconut water comprises POD enzymes.

19. Coconut water according to claim 18, wherein the coconut water comprises active PPO and POD enzymes.

20. Coconut water according to claim 18, having a viable organism count, measured as colony forming units/millilitre by standard plate counts, of between 0-10 cfu/ml.

21. Coconut water according to claim 18, wherein at least 95 wt. %, preferably at least 99 wt. % of the dry matter present in the coconut water has a particle size smaller than 500 nm.

22. Coconut water according to claim 18 as obtained by a process comprising subjecting a raw juice feed to microfiltration to obtain the coconut water and a retentate juice product, wherein the microfiltration is performed as a cross-flow filtration over a sieve, which sieve has openings that are smaller than the dimensions of the microorganisms present in the raw juice feed and wherein over the sieve a high frequency back pulsing is applied.
